(19) United States
(12) Patent Application Publication
(10) Pub. No.: US 2026/0287133 A1
(43) Pub. Date: Sep. 24, 2026

(54) TRACK LIGHTING SYSTEM

(71) Applicant: SIGNIFY HOLDING B.V., EINDHOVEN (NL)

(72) Inventors: TIES VAN BOMMEL, HORST (NL); ROBERT JACOB PET, WAALRE (NL)

(21) Appl. No.: 19/484,635

(22) PCT Filed: Jun. 6, 2024
(86) PCT No.: PCT/EP2024/065586

§ 371 Date: Nov. 14, 2025

(30) Foreign Application Priority Data
Jun. 12, 2023 (EP) 23178574.2

(51) Int. Cl. F21S 8/06; F21V 3/02; F21V 8/00; F21V 21/30; F21V 21/35; F21V 23/06; F21Y 107/50; F21Y 115/10

(52) U.S. Cl. CPC F21S 8/066; F21V 3/02; F21V 21/30; F21V 21/35; F21V 23/06; G02B 6/0036; G02B 6/0043; G02B 6/0046; F21V 2200/20; F21Y 2107/50; F21Y 2115/10

(57) ABSTRACT

A track lighting system (1) with: a LED light source (10) configured to emit LED light, a light exit window (3) extending in a first plane (P1) and having a first axis (A1) perpendicular to the first plane (P1), a longitudinal track (4) extending along a longitudinal axis (LA) having a mounting face extending in a second plane (P2), a connector (5) configured for mechanically and electrically connecting the luminaire (2) to the track (4), wherein the connector (5) is configured to be movable along the longitudinal axis (LA), and the connector (5) is configured to provide the luminaire (2) with a degree of freedom of rotation over a rotation angle (α) and/or tilting over a tilting angle (β) with respect to the second plane (P2). The light exit window (3) is configured to output luminaire light comprising a diffuse light component (C2) and a directional light component (C1), wherein a main directional light emission direction (Ddir) of the directional light component (C1) is non-parallel to the first axis (A1).

### FIELD OF INVENTION

The invention relates to the field of lighting and in particular to the field of track lighting systems.

### BACKGROUND OF THE INVENTION

A common way of maintaining an indoor light infrastructure is to have electrified tracks on which spotlights are mounted so that they may be adjusted to illuminate specific areas of interest.

Furthermore, CN 208735366 U describes illumination lamps and lanterns, for rail tunnels. The utility model discloses a luminous body for a track lamp in order to solve present rail tunnel lamp problems. The track panel lamp includes a rail joint, a power pack, a fixed position rotation support, a lamp body, a lamp plate, a luminous mirror surface, wherein the upper end of the power pack is connected with the rail joint, and the lower extreme of the power pack is connected to the fixed position rotation support. The fixed position rotation support passes through the lamp body and drives the luminous mirror surface rotation. The luminous mirror plane array is set up in the lamp body, and the luminous mirror surface is formed by the concatenation of a plurality of long rod lenses, which is provided with the LED lamp plate situated between the lamp body's top inner wall and the luminous mirror surface.

However, the illumination characteristics of the track lighting system in the prior art are limited. Therefore, it is desired to provide a track lighting system which is more versatile in terms of its illumination characteristics.

It is therefore generally desired to provide large area LED luminaires which can be connected to a track of a track lighting system. The main function of track lighting systems is directional illumination of objects close to a wall such as paintings. Therefore, it is further desired to provide a track lighting system comprising a track and a large area luminaire having a light exit window providing both ambient light and directional light.

DE 10 2014 209999 provides a lighting device in which an operation for fitting a movable light projecting means to a rail is less restricted by surrounding environment and more convenient fitting work can be carried out. The lighting device comprises a rail in which a pair of rail walls, a pair of rail hooks protruding out of inner surfaces of the pair of rail walls facing to each other, a pair of engaging walls and movable light projection means formed with a pair of sliding hooks capable of being protruded outside from the pair of engaging walls and engaged with the pair of rail hooks of the rail means, and the movable light projecting means can slide along the rail means.

### SUMMARY OF THE INVENTION

The object of the invention is to provide a track lighting system which is more versatile in terms of its illumination characteristics.

It is a further object of the invention to provide a track lighting system comprising a track and a large area luminaire with which the light exit window looks uniform/homogeneous at a viewing distance, yet more light is projected under an angle to a target surface, such as a wall or a ceiling.

According to a first aspect of the invention, this and other problems are overcome by a track lighting system, wherein the track lighting system comprises: a luminaire, the luminaire comprising: a LED light source configured to, in operation, emit LED light, and a light exit window extending in a first plane having a first axis perpendicular to the first plane, a longitudinal track extending along a longitudinal axis having a mounting face extending in a second plane, and a connector configured for mechanically and electrically connecting the luminaire to the track, the connector being configured to be movable along the longitudinal axis, and the connector being configured to provide the luminaire with a degree of freedom of rotation over a rotation angle and/or tilting over a tilting angle with respect to the second plane, and wherein the light exit window is configured to output luminaire light comprising a diffuse light component and a directional light component, wherein a first main light emission direction, of the directional light component is non-parallel to the first axis.

By providing a track lighting system with a luminaire having a light exit window configured to provide a combination of a directional light component and a diffuse light component, a direct illumination of a small area and a general diffuse illumination of a large area is provided. Thereby, the need for two distinct luminaires in the track lightning system, one for directional light and one for diffuse light is removed. Thus, a track lighting system comprising a track and a large area luminaire with which the light exit window looks uniform/homogeneous at a viewing distance, yet more light is projected under an angle to a target surface, such as a wall or a ceiling, is provided.

Consequently, and in addition by providing that the connector being configured to provide the luminaire with a degree of freedom of rotation over a rotation angle and/or tilting over a tilting angle with respect to the second plane, a track lighting system which is more versatile in terms of its illumination characteristics is provided.

In an embodiment the light exit window is rotationally symmetric around the first axis. Thus, the light exit window has an outer appearance that is independent of the rotation around the first axis. This in turn allows the luminaire in the track lightning system to vary the main directional light emission direction without varying the outer appearance of the track lighting system.

In embodiments, the luminaire may comprise the connector.

In an embodiment the light exit window has a N-fold rotational symmetry around the first axis, wherein N is greater than 5 or 7.

Thus, the light exit window has an outer appearance that does not change as long as the light exit window is rotated by an angle around the first axis that is a manifold of 360 degrees divided by N.

In an embodiment the light exit window has a circular symmetry around the first axis.

Consequently, the rotation of the luminaire is not visible, while the light emission direction of the directional light component is changing, allowing to alter the light distribution of the luminaire without changing the luminaires outer appearance.

In an embodiment the connector comprises a fixation element configured for mechanically and electrically connecting the luminaire to the track, and a rotation and/or tilt element configured to provide the luminaire with the degree of freedom.

The connector may further comprise a locking element configured to restrict the rotation over a rotation angle and/or tilting over a tilting angle.

The locking element thus permits to avoid unwanted rotation or tilting of the LED light-source and/or light exit window.

The fixation element and the rotation and/or tilt element advantageously provides the luminaire with electrical power and movable mechanical attachment.

In an embodiment the luminaire or connector further comprises a direction marker indicating the first main emission direction of the directional light component.

The direction marker facilitates aligning the direction of the first axis during a setup of the luminaire.

In an embodiment a second light emission direction of the diffuse light component is parallel to the first axis.

Consequently, the second main light emission direction of the diffuse light component is perpendicular to the light exit window which in turn allows to easily align the second main light emission direction of the diffuse light component as it is easily identifiable by a user due to being perpendicular to the light exit window.

In an embodiment the first main light emission direction is at an angle γ with respect to the first plane, wherein γ is equal or greater than 10 degrees and equal or less than 80 degrees, preferably in a range from 20 to 70 degrees, more preferably from 30 to 60 degrees and most preferably from 35 to 55 degrees.

In an embodiment the connector comprises a ball joint to provide the luminaire with a degree of freedom.

Advantageously, the ball joint allows the light exit window to be tilted.

In an embodiment the luminaire further comprises a tapered light guide tapering in a direction away from the light source, said tapered light guide comprises a light scattering dot pattern arranged on a bottom and/or top major surface of said tapered light guide, where the diffuse light component is provided by LED light being coupled out of the tapered light guide by reflection on the light scattering dot pattern, and where the directional light component is provided by LED light coupled out of the tapered light guide by reflection on areas outside said scattering dot pattern on the bottom surface of said tapered light guide.

One advantage of this embodiment is that a diffuse light component and a direct light component can be created using a limited amount of LED light sources.

In an embodiment the luminaire further comprises a light guide comprising a first and a second type of light out-coupling features, wherein the diffuse light component is provided by said first type of light out-coupling features, and wherein the directional light component is provided by the second type of light out-coupling features.

The objective of this embodiment is to provide the luminaire with two distinct light out-coupling features allowing to independently adjust the diffuse light component and the directional light component.

In an embodiment the LED light source comprises at least a first and a second set of light emitting elements, where the diffuse light component is provided by the first set of light emitting elements, where light exit surfaces of the light emitting elements of the first set are facing in a first direction substantially perpendicular to said light exit window, where the directional light component is provided by the second set of light emitting elements, where light exit surfaces of the light emitting elements of the second set are facing in a second direction, and where the first direction is different from the second direction.

Consequently, the embodiment provides a track lighting system that has a diffuse light component and a directional light component, without having to use a non-planar light exit window.

In a further embodiment, the light exit window comprises a forward-scattering diffuser, where the diffuse light component is provided by light emitted by the set of first light emitting elements impinging on the forward-scattering diffuser, and where the directional light component is provided by light emitted by the second set of light emitting elements and impinging on the forward-scattering diffuser.

Thereby, a symmetric light distribution is obtained in a simple manner.

In an embodiment a rotation of the luminaire around the first axis does not change its visual appearance.

The advantage of this embodiment is that the rotation of the luminaire in order to set the direction of the direct light component is possible without changing the visual appearance.

In an embodiment the light exit window has a circular shape.

This embodiment is advantageous as a rotation of any angle around the first axis does not change the visual appearance of the track lighting system. Therefore, it is allowed to precisely set the direction of the main directional light component without changing the visual appearance of the track lighting system.

In an embodiment the directional light component in the first main emission direction has a first brightness, and wherein a second main light emission direction of the diffuse light component has a second brightness, wherein the first brightness is equal to or greater than twice the second brightness.

In an embodiment the diffuse light component has a first luminous flux, and the directional light component has a second luminous flux, wherein the first luminous flux is equal to or greater than one and a half times the second luminous flux.

In an embodiment the track lighting system comprises a plurality of the luminaires.

In an embodiment the track lighting system comprises one or more further luminaire being different in architecture from the luminaires.

In embodiments, the diffuse light component may be white light having a correlated color temperature in a range from 2000K to 6500K and/or a color rendering index of at least 80.

In embodiments, the directional light component may be white light having a correlated color temperature in a range from 2000K to 6500K and/or a color rendering index of at least 80.

In embodiments, the luminaire light may be white light having a correlated color temperature in a range from 2000K to 6500K and/or a color rendering index of at least 80.

In embodiments, the diffuse light component may have a different correlated color temperature than the directional light component. In examples the difference may be at least 500K. Typically, the correlated color temperature of the directional light component may be higher than the diffuse light component.

This in turn may allow to have, what many people associate with a more welcoming lighting for the illumination of a larger area and have a higher color temperature for applications where that is desired, for example in paintings, pictures, etc.

In embodiments, the diffuse light component may have (about) the same correlated color temperature than the directional light component.

In embodiments, the difference in color temperature of the diffuse light component and the directional light component may be less than 300K.

By providing a plurality of luminaires, the track lighting system is able to illuminate directly multiple small areas, while providing general diffuse lighting for a large area in which the track lightning system is used.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 depicts a cross-section of an embodiment of the invention with two sets of light emitting elements.

FIG. 2 depicts a cross-section of an embodiment of the invention with a tapered light guide.

FIG. 3 depicts a cross-section of an embodiment of the invention with a first and second type of light out coupling feature.

FIG. 4 depicts a cross-section of an embodiment that corresponds to FIG. 1, with a tilt angle and a rotation angle shown.

FIG. 5 is a perspective view of a luminaire showing different light components.

FIG. 6 is a perspective view of a track lighting system of an embodiment of the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

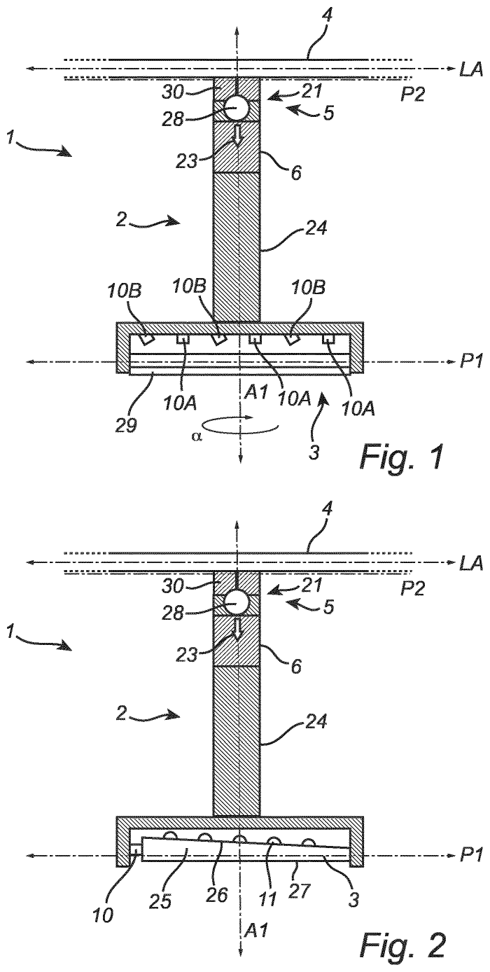

FIGS. 1, 2, 3 and 4 each show an embodiment of a track lighting system 1 according to the invention. The figures illustrate a cross-sectional view of a track lighting system 1 each. The difference between the embodiments shown lies within the employed solution for the creation of a diffuse and directional light component. Nevertheless, the different embodiments of FIG. 1, 2, 3 and are generally compatible, meaning that luminaires with different solutions for the creation of a diffuse and directional light component can be operated on the same track.

Generally, and irrespective of the embodiment, the track lighting system 1 comprises a luminaire 2. The luminaire 2 in turn comprises at least one LED light source 10 configured to, in operation, emit LED light. The LED light source 10 may be powered by electric power. The light emitted by the LED light source 10 is exiting the luminaire 2 via a light exit window 3. The light exit window 3 therefore may be of a transparent material, such as for example glass or acrylic glass. The light exit window 3 may be plane or it may be slightly curved. Furthermore, the light exit window 3 extends in a first plane P1, and defines a first axis A1, the axis A1 being perpendicular to said first plane P1. The track lighting system 1 further comprises a longitudinal track 4 extending along a longitudinal axis LA. For example, the longitudinal track 4, when mounted in an indoor environment, may be horizontally placed parallel to the ceiling of a room. Alternatively, the longitudinal track 4 of the track lighting system 1 may be mounted with an inclination in relation to a horizontal direction. The longitudinal track 4 has a mounting face which extends in a second plane P2. The mounting face may form the lowest part of the longitudinal track and the surface to which the luminaires are attached. Additionally, the track lighting system 1 comprises a connector 5 configured for mechanically and electrically connecting the luminaire 2 to the longitudinal track 4. The connector 5 is configured to be movable along the longitudinal axis LA. For example, the connector 5 is connected to the track 4 such that it can be manually slidably moved along the track 4. Additionally, the connector 5 is configured to provide the luminaire 2 with a degree of freedom of rotation over a rotation angle and/or tilting over a tilting angle with respect to the second plane P2. The angle of rotation a is shown in FIG. 1, and the tilting angle β is shown in FIG. 4. It is to be understood that in the embodiments shown in FIGS. 1, 2 and 3, the luminaire is also rotatable in respect to the tilting angle β, and that in the embodiments shown in FIGS. 2, 3 and 4 the luminaire is also rotatable in respect to the angle of rotation a around the first axis A1, even when that is not explicitly shown in the drawings. The luminaire 2 may be tilted around any axis that is parallel to the second plane P2.

Furthermore, the light exit window 3 is configured to output luminaire light comprising a diffuse light component C2 with a second main light emission direction Ddif being substantially parallel to the first axis A1, i.e., perpendicular to the light exit window 3, and a directional light component. Substantially parallel is in this connection intended to mean that the second main light emission direction Ddif deviates from the first axis A1 with preferably not more than +/−5 degrees, alternatively+/−10 degrees. The second main light emission direction Ddif of the diffuse light component C2 may be the direction in which the diffuse light component C2 has the highest luminous intensity. Alternatively, the second main light emission direction Ddif may be the average direction of the directions with the highest luminous intensities. A main directional light emission direction Ddir, of the directional light component is non-parallel to the first axis A1. The main directional light emission direction Ddir of the directional light component C1 may be the direction in which the directional light component C1 has the highest luminous intensity. Non-parallel should in this connection be understood in the sense that the main directional light emission direction Ddir of the directional light component C1 is deviating from the first axis A1 by at least 20 degrees, or alternatively 30 degrees. The luminaire is arranged such that by rotating the luminaire over the rotation angle (α) the first main light emission direction (Ddir) is changed without changing the visual appearance of the light exit window.

The light exit window 3 may be rotationally symmetric around the first axis A1 as shown in FIG. 1. Even though FIG. 1 shows a light exit window 3 that takes the form of a cylinder, other types of shapes are also perceivable, for example, a hollow half ellipsoid, or other sections of hollow ellipsoids. It is noted that a sphere is a special case of an ellipsoid where all the radii are the same.

The connector 5 may comprise a fixation element 30 configured for mechanically and electrically connecting the luminaire 2 to the track 4 and a rotation and/or tilt element 21 configured to provide the luminaire 2 with a degree of freedom. The fixation element 30 may comprise electrically conductive materials arranged such that the fixation element 30 connects the luminaire 2 electrically with the track. The rotation and/or tilt element may be for example a joint or a hinge. The fixation element 30 may further comprise spring loaded protrusions that are compressed before being inserted in a slit in the longitudinal track 4, with which the protrusions thereafter interact to attach the connector 5 to the track 4. Alternatively, the fixation element 30 may comprise a threaded rod attached to a retainer element, for example a t-nut, that is inserted into an open end of the longitudinal track 4, thereafter moved into the desired position in which the threaded rod is turned in relation to the retainer to clamp the connector 5 to the longitudinal track 4. The connector 5 may further comprise a locking element 6 configured to restrict the rotation over a rotation angle and/or tilting over a tilting angle. The locking element 6 may be a clamp that is applying a force onto a part of the rotation and/or tilt element 21 in order to restrict the movement and thereby the rotation and/or tilting of the luminaire 2. The clamp may be operated via a spring that can be manually compressed or extended. The clamp would then by default lock the rotation and/or tilt element 21 and only when a force is applied to the spring allow movement of the rotation and/or tilt element 21. Alternatively, the rotation and/or tilting may be locked by a screw applying a force onto parts of the rotation and/or tilt element 21 and thereby locking the rotation and/or tilt element 21.

The connector 5 may further comprise direction marker 23 configured to align the direction of the first axis A1. The direction marker 23 may be an indicator indicative of the direction of the first axis A1 and/or of the main direction of emission. The direction marker 23 may be used even when the track lighting system 1 is not in operation. In order to align the first axis A1 an indicator may be placed on the housing 24 indicating the direction of the first axis A1. The indicator may take the shape of an arrow. Furthermore, the indicator may be placed on a visible part of the housing facing 24 the second plane P2.

FIG. 2 depicts a cross-section view of an embodiment of a track lighting system 1 which differs from the embodiment shown in FIG. 1 and described above in that the light exit window 3 further comprises a tapered light guide 25 tapering in a direction away from the light source 10. The tapered light guide 25 comprises a light scattering dot pattern 11 arranged on a bottom major surface 26 and/or top major surface 27 of said tapered light guide 25. The diffuse light component is provided by LED light being coupled out of the tapered light guide 25 by reflection on the light scattering dot pattern 11, and the directional light component is provided by LED light coupled out of the tapered light guide 25 by reflection on areas outside said scattering dot pattern 11 on the bottom major surface 26 of the tapered light guide 25. It is noted that the tapered light guide 25 may be covered by an additional layer of an optical transparent layer.

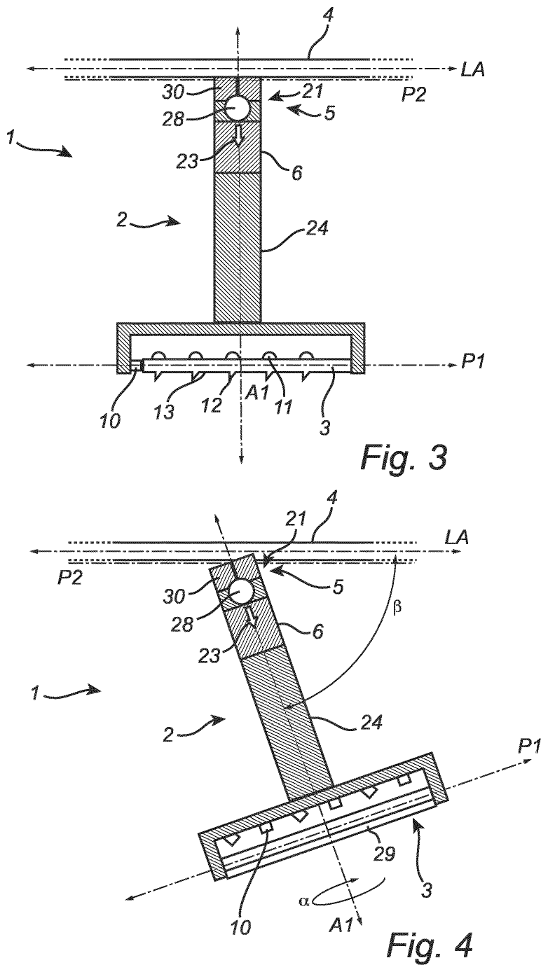

FIG. 3 illustrates a cross-section of an embodiment of a track lighting system 1 which differs from the embodiments shown in FIGS. 1 and 2 and described above in that the light exit window 3 comprises a light guide comprising a first type of light out-coupling features 13 and a second type of light out-coupling features 12. The diffuse light component is provided by said first type of light out-coupling features 13, and the directional light component is provided by the second type of light out-coupling features 12. The first type of light outcoupling feature 13 may be a scattering dot pattern 11. The second type of light out-coupling feature 12 may be a wedge shaped structure on a surface of the light exit window 3. Alternatively, the second type of light out-coupling feature 12 may be holes in the light exit window 3, and the first type of light out-coupling feature 13 may be flat surfaces interposed between the holes.

Referring again to FIG. 1 an embodiment of a track lighting system 1 is shown in cross-section in this embodiment the LED light source 10 comprises at least a first set of light emitting elements 10A and a second set of light emitting elements 10B. The diffuse light component is provided by the first set of light emitting elements 10A wherein light exit surfaces of the light emitting elements of the first set are facing in a first direction substantially perpendicular to said light exit window 3. Substantially perpendicular is in this connection intended to mean that the direction that the light exit surface of the first set of light emitting elements 10A are facing is deviating less than 10 degrees, preferably less than 5 degrees, from a normal of the first plane P1. The directional light component is provided by the second set of light emitting elements 10B. The light exit surfaces of the light emitting elements of the second set of light emitting elements 10B are facing in a second direction, and the first direction is different from the second direction. The second direction may deviate from the first direction by an angle of at least 20 degrees, or at least 30 degrees. The light emitting elements of the first and second set 10A, 10B may be arranged in an alternating way as shown in FIG. 1. Alternatively, the first set of light emitting elements 10A may be placed closer to the first axis A1 than the second set of light emitting elements 10B. A further alternative is to place the light emitting elements of the first set 10A on one side of the luminaire 2 and the second set of light emitting elements 10B on another side.

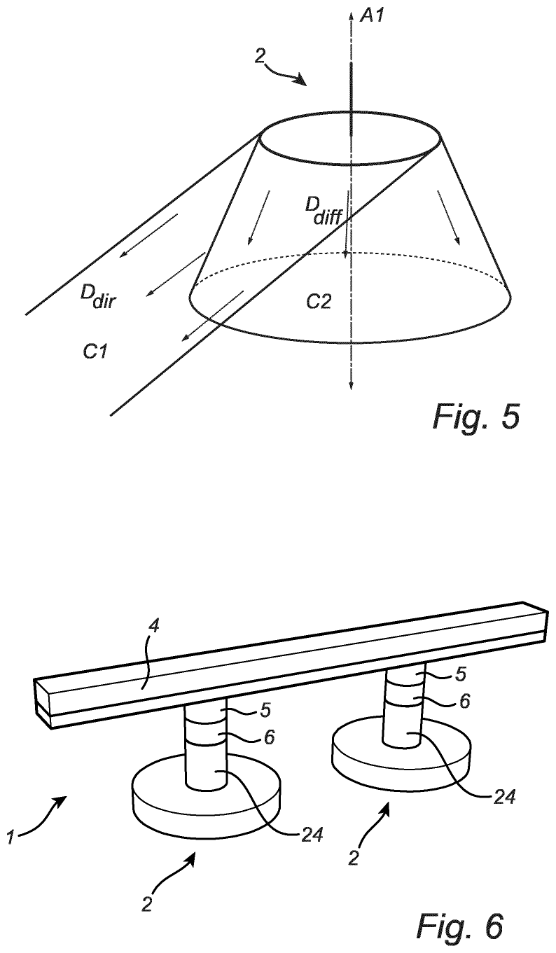

FIG. 5 shows schematically a perspective view of a luminaire 2 of a track lighting system 1 according to the invention in which a second main light emission direction Ddif of the diffuse light component C2 is parallel to the first axis A1. Further, a main directional light emission direction Ddir of the directional light component C1 is oriented in an angle of between 0 and 90 degrees with the first axis A1.

In an embodiment the connector 5 comprises a ball joint 28 to provide the luminaire 2 with a degree of freedom. The ball joint 28 may provide the luminaire 2 with a degree of freedom of at least one, preferably all, of the following: a rotation around the first axis A1, a rotation around an axis parallel to the second plane P2, and a rotation around an axis that is perpendicular to the aforementioned axis and parallel to the second plane P2. In other words, the ball joint 28 may preferably provide the luminaire 2 of the track lighting system 1 with three degrees of freedom. The ball joint may be placed on a part of the luminaire close to the track 4. Alternatively, the ball joint may be placed on the distal side of the cylindrical housing 24 in respect to the track 4.

Back in FIG. 1 a further embodiment of the track lighting system 1 is shown, wherein the light exit window 3 comprises a forward-scattering diffuser 29. The diffuse light component C2 is provided by light emitted by the first light emitting elements 10A impinging on the forward-scattering diffuser. The directional light component C1 is provided by light emitted by the second light emitting elements 10B and impinging on the forward-scattering diffuser 29.

In an embodiment a rotation of the luminaire 2 around the first axis A1 does not change its visual appearance. Preferably, the rotation is less than 360 degrees. In case the light exit window 3 is square shaped, a rotation around 90 degrees would lead to the same visual appearance. For the case of a hexagonal shaped light exit window 3 a rotation around 60 degrees would result in an unchanged visual appearance. The visual appearance may be the view a user or bystander has of the basic features of the luminaire 2 in a mounted but non-operational state. That means that for example small surface structures on the light exit window 3 do not affect the visual appearance.

In an embodiment the light exit window 3 has a circular shape. The light exit window 3 may be partly enclosed by a cylindrical housing 24.

In an embodiment the radiation pattern of the luminaire 2 in the direction of a main luminous intensity of the luminaire 2 is not rotationally symmetric to the first axis A1.

In FIG. 6 a perspective view of a track lighting system 1 with two luminaires 2 is shown. The luminaires 2 of the track lighting system 1 are attached to the same track but are longitudinally displaced in relation to each other. Even though there are only two luminaires 2 shown in FIG. 5 more luminaires 2 are possible to operate in the track lighting system 1. The luminaires 2 may be identical or mutually different luminaires according to the invention.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1- A track lighting system, wherein the track lighting system comprises:
a luminaire comprising:
a LED light source configured to, in operation, emit LED light, and
a light exit window having a visual appearance, extending in a first plane and having a first axis perpendicular to the first plane;
a longitudinal track extending along a longitudinal axis having a mounting face extending in a second plane; and
a connector configured for mechanically and electrically connecting the luminaire to the track, the connector being configured to be movable along the longitudinal axis, and the connector being configured to provide the luminaire with a degree of freedom of rotation around the first axis over a rotation angle (α) and/or tilting over a tilting angle (β) with respect to the second plane; and
wherein the light exit window is configured to output luminaire light comprising a diffuse light component and a directional light component, wherein a first main light emission direction (Ddir) of the directional light component is non-parallel to the first axis, and
wherein the luminaire is arranged such that by rotating the luminaire over the rotation angle (α) the first main light emission direction (Ddir) is changed without changing the visual appearance of the light exit window, and
wherein the LED light source comprises at least a first and a second set of light emitting elements, wherein light exit surfaces of the light emitting elements of the first set are facing in a first direction substantially perpendicular to said light exit window (3),
light exit surfaces of the light emitting elements of the second set are facing in a second direction, wherein the first direction is different from the second direction, wherein the light exit window (3) comprises a forward scattering diffuser (29), wherein
the diffuse light component (C2) is provided by light emitted by the first set of light emitting elements impinging on the forward-scattering diffuser, and wherein
the directional light component (C1) is provided by light emitted by the second set of light emitting elements and impinging on the forward-scattering diffuser.

2- A track lighting system according to claim 1, wherein the light exit window has a N-fold rotational symmetry around the first axis, wherein N is greater than 5.

3- A track lighting system according to claim 2, wherein the light exit window has a circular symmetry around the first axis.

4- A track lighting system according to claim 1, wherein the connector comprises:
a fixation element configured for mechanically and electrically connecting the luminaire to the track, and
a rotation and/or tilt element configured to provide the luminaire with the degree of freedom.

5- A track lighting system according to claim 1, wherein the connector further comprises a locking element configured to restrict (i) the rotation over a rotation angle (α) and/or (ii) tilting over a tilting angle (β).

6- A track lighting system according to claim 1, wherein the connector further comprises a direction marker indicating the first main emission direction (Ddir) of the directional light component.

7- A track lighting system according to claim 1, wherein a second main light emission direction (Ddif) of the diffuse light component is parallel to the first axis.

8- A track lighting system according to claim 1, wherein the first main light emission direction (Ddir) is at an angle γ with respect to the first plane, wherein γ is equal to or greater than 10 degrees and equal to or less than 80 degrees.

9- A track lighting system according to claim 1, wherein either,
the luminaire further comprises a tapered light guide tapering in a direction away from the light source, said tapered light guide comprising a light scattering dot pattern arranged on a bottom major surface and/or top major surface of said tapered light guide, wherein
the diffuse light component is provided by LED light being coupled out of the tapered light guide by reflection on the light scattering dot pattern, and wherein the directional light component is provided by LED light coupled out of the tapered light guide by reflection on areas outside said scattering dot pattern on the bottom surface of said tapered light guide, or
the luminaire further comprises a light guide comprising a first type of light outcoupling feature and a second type of light out-coupling feature wherein the diffuse light component is provided by the first type of light out-coupling feature, and wherein the directional light component is provided by the second type of light out-coupling feature, or
the LED light source comprises at least a first and a second set of light emitting elements, wherein the diffuse light component is provided by the first set of light emitting elements, wherein light exit surfaces of the light emitting elements of the first set are facing in a first direction substantially perpendicular to said light exit window, wherein the directional light component is provided by the second set of light emitting elements, wherein light exit surfaces of the light emitting elements of the second set are facing in a second direction, and wherein the first direction is different from the second direction.

10- (canceled)

11- A track lighting system according to claim 1, wherein the directional light component in the first main emission direction (Ddir) has a first brightness, and wherein a second second-main light emission direction (Ddif) of the diffuse light component has a second brightness, wherein the first brightness is equal to or greater than twice the second brightness.

12- A track lighting system according to claim 1, wherein the diffuse light component has a first luminous flux and the directional light component has a second luminous flux, wherein the first luminous flux is equal to or greater than one and a half times the second luminous flux.

13- A track lighting system according to claim 1, wherein the track lighting system comprises a plurality of the luminaires.

14- A track lighting system according to claim 1, wherein the track lighting system comprises one or more further luminaire being different in architecture from the luminaires.
